(19) United States
(12) Patent Application Publication
(10) Pub. No.: US 2024/0199025 A1
(43) Pub. Date: Jun. 20, 2024

(54) VEHICLE CONTROL DEVICE

(71) Applicant: TOYOTA JIDOSHA KABUSHIKI KAISHA, Toyota-shi (JP)

(72) Inventor: Tatsuyuki HIRAI, Susono-shi (JP)

(73) Assignee: TOYOTA JIDOSHA KABUSHIKI KAISHA, Toyota-shi (JP)

(21) Appl. No.: 18/467,771

(22) Filed: Sep. 15, 2023

(30) Foreign Application Priority Data
Dec. 14, 2022 (JP) 2022-199318

(51) Int. Cl. B60W 30/18; B60W 60/00; G08G 1/16

(52) U.S. Cl. CPC B60W 30/18163; B60W 60/001; G08G 1/167; B60W 2552/53; B60W 2554/4041

(57) ABSTRACT

The vehicle control device is capable of executing a first trace process of recognizing a traveling lane on which the host vehicle is traveling and controlling the host vehicle so that the host vehicle travels along the traveling lane on the basis of the information acquired from the in-vehicle sensor, and controlling the host vehicle so that the host vehicle travels along the trajectory of the preceding vehicle when there is a preceding vehicle traveling in front of the host vehicle in a situation where the traveling lane cannot be recognized while executing the first trace process. The vehicle control device does not execute the second trace control when there is a possibility that there is another vehicle running in parallel with the host vehicle.

### CROSS-REFERENCE TO RELATED APPLICATION

This application claims priority to Japanese Patent Application No. 2022-199318 filed on Dec. 14, 2022, incorporated herein by reference in its entirety.

### BACKGROUND

### 1. Technical Field

The present disclosure relates to a vehicle control device that causes a host vehicle to travel along a traveling lane.

### 2. Description of Related Art

A vehicle control device that causes a host vehicle to travel along a traveling lane has been proposed (for example, see Japanese Unexamined Patent Application Publication No. 2013-097714 (JP 2013-097714 A) below). The vehicle control device according to JP 2013-097714 A includes a camera and a processor. The camera sequentially captures the foreground of a vehicle and acquires image data. The processor analyzes the image data to recognize the traveling lane in which the host vehicle is traveling and a position of the host vehicle in the width direction of the traveling lane. Then, the processor controls the host vehicle (steering device) such that the host vehicle travels along the traveling lane, based on the recognition result.

A vehicle equipped with the vehicle control device according to JP 2013-097714 A may travel in a section (for example, an intersection) in which a lane marking line that defines the traveling lane is not drawn, a section in which a lane marking line is blurred, a section in which snow is accumulated on a road surface, or the like. Under such circumstances, the processor may not be able to recognize the traveling lane. In this case, a vehicle control device that controls a host vehicle so that the host vehicle travels along a trajectory of a preceding vehicle has been proposed (for example, see Japanese Unexamined Patent Application Publication No. 2020-050086 (JP 2020-050086 A) below). When the traveling lane is recognized, the vehicle control device according to JP 2020-050086 A controls the host vehicle based on the recognized traveling lane. When the traveling lane is not recognized, the vehicle control device according to JP 2020-050086 A controls the host vehicle based on the trajectory of the preceding vehicle.

### SUMMARY

In the vehicle control device described in JP 2020-050086 A, in a case in which the preceding vehicle travels so as to change the lateral position thereof when the host vehicle is controlled based on the trajectory of the preceding vehicle, the host vehicle is controlled such that the lateral position of the host vehicle also changes as in the case of the preceding vehicle. In this case, the host vehicle may come close to or come into contact with another vehicle traveling side by side with respect to the host vehicle. For example, when the host vehicle enters an intersection in which no lane marking line is marked, the vehicle control device described in JP 2020-050086 A controls the traveling of the host vehicle based on the trajectory of the preceding vehicle. At this time, the preceding vehicle may change the lateral position within the intersection, and after exceeding the intersection, the preceding vehicle may enter a traveling lane adjacent to the traveling lane in which the preceding vehicle has traveled so far. In such a case, when the host vehicle follows the preceding vehicle, the host vehicle may come close to or come into contact with the parallel-traveling vehicle traveling in the adjacent lane from the beginning.

An object of the present disclosure is to provide a vehicle control device capable of improving safety of a host vehicle.

In order to achieve the above object, a vehicle control device according to the present disclosure includes: an in-vehicle sensor that acquires information on an object present around a host vehicle and information on a traveling state of the host vehicle; and a processor that is able to execute first trace control in which, based on the information acquired from the in-vehicle sensor, a traveling lane in which the host vehicle is traveling is recognized and the host vehicle is controlled to move along the traveling lane, and that is able to execute second trace control in which, when there is a preceding vehicle that is traveling in front of the host vehicle under a situation in which the traveling lane is not able to be recognized during execution of the first trace control, the host vehicle is controlled to move along a trajectory of the preceding vehicle. The processor is configured not to execute the second trace control when there is a possibility that another vehicle traveling side by side with respect to the host vehicle is present.

According to the present disclosure, in a case in which there is a possibility that the other vehicle (parallel-traveling other vehicle) traveling side by side with respect to the host vehicle is present, the processor does not execute the second trace control in which the host vehicle is controlled to move along the trajectory of the preceding vehicle. Thus, it is possible to suppress the host vehicle from coming close to or coming into contact with the parallel-traveling other vehicle by executing the second trace control when there is a possibility that the parallel-traveling other vehicle is present. Therefore, the safety of the host vehicle can be improved.

In the vehicle control device according to an aspect of the present disclosure, when another vehicle located in a predetermined range including a lateral side of the host vehicle is detected based on the information acquired from the in-vehicle sensor, the processor determines that there is a possibility that the other vehicle traveling side by side with respect to the host vehicle is present.

When the other vehicle located in the predetermined range around the host vehicle is detected based on the information acquired from the in-vehicle sensor, it is extremely likely that the detected other vehicle is the parallel-traveling other vehicle. Since the processor does not execute the second trace control in such a case, the safety of the host vehicle can be improved.

In the vehicle control device according to another aspect of the present disclosure, when determination is made that the host vehicle is traveling in a congested section, the processor determines that there is a possibility that the other vehicle traveling side by side with respect to the host vehicle is present.

In a case in which the host vehicle is traveling in the congested section, there is a possibility that the parallel-traveling other vehicle is present. Since the processor does not execute the second trace control when the host vehicle is traveling in the congested section, it is possible to improve the safety of the host vehicle.

In the vehicle control device according to another aspect of the present disclosure, when the host vehicle is traveling on a road in which the number of lanes in a traveling direction of the host vehicle is two or more, the processor determines that there is a possibility that the other vehicle traveling side by side with respect to the host vehicle is present.

Since there is a lane adjacent to the current lane when the number of lanes in the traveling direction of the host vehicle is two or more, there is a possibility that the parallel-traveling other vehicle is present in the adjacent lane. In this case, since the processor does not execute the second trace control, it is possible to improve the safety of the host vehicle.

In the vehicle control device according to another aspect of the present disclosure, the processor stops control of the host vehicle, when determination is made that there is a possibility that the other vehicle traveling side by side with respect to the host vehicle is present, under the situation in which the traveling lane is not able to be recognized.

Accordingly, when the processor determines that there is a possibility that the other vehicle traveling side by side with respect to the host vehicle is present, under the situation in which the traveling lane of the host vehicle is not able to be recognized, the operation of the host vehicle is left to the driver. Therefore, it is possible to suppress that the vehicle control device continues to control the host vehicle in a state in which the traveling lane cannot be recognized and thus the safety of the host vehicle is impaired.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram of a vehicle control device according to an embodiment of the present disclosure.

FIG. 2 is a plan view showing a predicted trajectory of the host vehicle;

FIG. 3 is a flowchart of a program for realizing a function of determining whether or not to execute the preceding vehicle trajectory trace control according to the presence or absence of the parallel running vehicle;

FIG. 4 is a flowchart of a program for realizing a function of executing the preceding vehicle trajectory trace control;

FIG. 5 is a flow chart of a program for realizing a function of determining whether or not to execute the preceding vehicle trajectory tracing control according to the congestion degree of the traveling lane; and

FIG. 6 is a flow chart of a program for realizing a function of determining whether or not to execute the preceding vehicle trajectory tracing control according to the presence or absence of a neighboring driving lane.

### DETAILED DESCRIPTION OF EMBODIMENTS

### Overview

A vehicle control device 1 according to an embodiment of the present disclosure is mounted on a vehicle V (hereinafter, referred to as an “own vehicle”) having an autonomous driving function. The vehicle control device 1 has a function of controlling the speed and the steering angle of the host vehicle.

### Specific Configuration

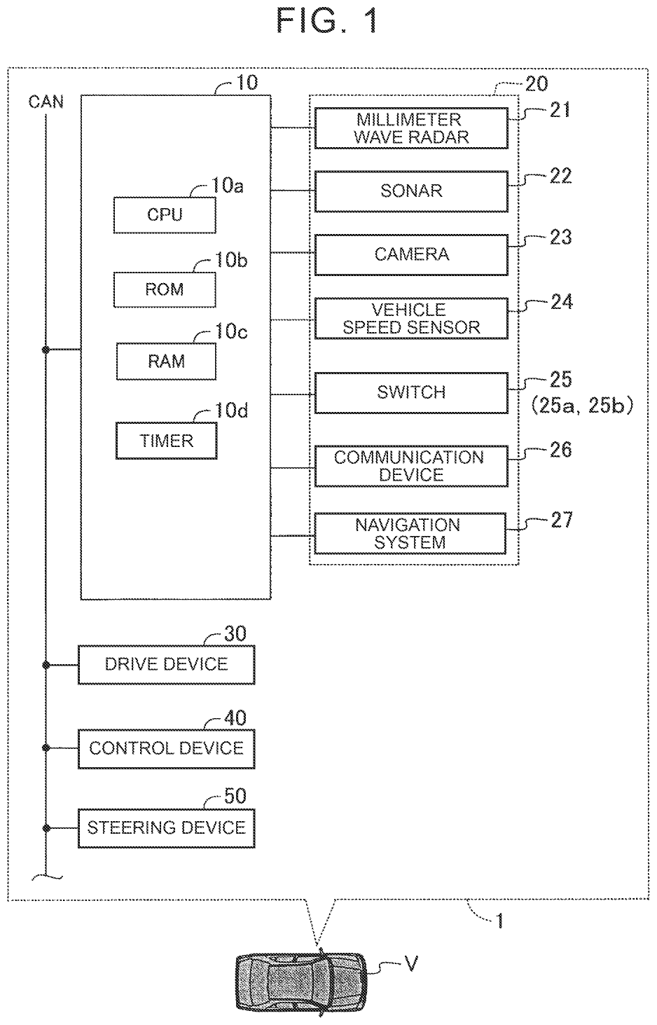

As illustrated in FIG. 1, the vehicle control device 1 includes a driving support ECU 10, an in-vehicle sensor 20, a drive device 30, a braking device 40, and a steering device 50.

The driving support ECU 10 includes a CPU 10a, ROM 10b, RAM 10c, a timer 10d, and the like. The driving support ECU 10 is connected to another ECU (for example, a ECU of a drive device 30, a braking device 40, and a steering device 50, which will be described later) via a CAN.

The in-vehicle sensor 20 includes an ambient sensor that acquires information about a target that exists in the surroundings of the host vehicle. The in-vehicle sensor 20 includes, for example, a millimeter wave radar 21 as an ambient sensor, a sonar 22, and a camera 23.

The millimeter wave radar 21 includes a transmission/reception unit and a signal processing unit. The transmission and reception unit radiates a millimeter-wave band radio wave (hereinafter, referred to as “millimeter wave”) toward the front of the own vehicle, and receives a millimeter wave (reflected wave) reflected by a three-dimensional object located within a radiation range. The signal processing unit recognizes the distance between the subject vehicle and the three-dimensional object, the relative position (direction) of the three-dimensional object with respect to the subject vehicle, and the like on the basis of the time from the emission of the millimeter wave to the reception of the reflected wave by the transmitting/receiving unit, the phase difference between the transmitted millimeter wave and the received reflected wave, the attenuation degree of the reflected wave, and the like. The driving support ECU 10 is configured to transmit the recognition result.

The sonar 22 intermittently radiates an ultrasonic wave to a peripheral area of the own vehicle, and receives an ultrasonic wave (reflected wave) reflected by a three-dimensional object. The sonar 22 recognizes the distance between the subject vehicle and the three-dimensional object, the relative position (direction) of the three-dimensional object with respect to the subject vehicle, and the like based on the time from the transmission of the ultrasonic wave to the reception of the reflected wave. The sonar 22 transmits the recognition result to the driving support ECU 10.

The camera 23 includes an imaging device and an image analysis device. The imaging device incorporates, for example, a CCD. The imaging devices are installed on the front portion, the rear portion, the left side portion, and the right side portion of the own vehicle. The imaging device captures an image of a surrounding area of the own vehicle at a predetermined frame rate, and acquires image data. Each imaging device transmits image data to the image analysis device. The image analysis device analyzes the acquired image data and recognizes a target and a display existing around the host vehicle from the image. For example, the image analysis device recognizes other vehicles, guardrails, poles, lane marks (dividing lines, curbstones, separation bands, and the like that define the traveling lanes), and the like. The image analysis device transmits the recognition result to the driving support ECU 10.

Further, the in-vehicle sensor 20 includes a vehicle speed sensor 24. The vehicle speed sensor 24 includes a wheel speed sensor that generates one pulse signal (wheel pulse signal) every time a wheel of the host vehicle rotates at a predetermined angle. The vehicle speed sensor 24 measures the number of pulses in the unit time of the wheel pulse signal transmitted from the wheel speed sensor. The vehicle speed sensor 24 calculates the rotation speed (wheel speed) of each wheel based on the measured number of pulses. The vehicle speed sensor 24 calculates the speed (actual vehicle speed) of the host vehicle based on the wheel speed of each wheel. The vehicle speed sensor 24 transmits the calculation result to the driving support ECU 10.

Further, the in-vehicle sensor 20 includes a switch 25. The switch 25 includes an operation device for requesting the driver to execute various processes with respect to the vehicle control device 1. Specifically, the switch 25 includes a push-button type switch 25a and a switch 25b for requesting to execute vehicle speed control and steering angle control, which will be described later, respectively. Note that the switch 25b can be set to the ON state only when the switch 25a is in the ON state. That is, when the switch 25a is in the off-state, the switch 25b cannot be in the on-state.

The drive device 30 applies a driving force to the driving wheels. The drive device 30 includes an engine ECU, an internal combustion engine, a transmission, a drive force transmission mechanism that transmits the drive force to the wheels, and the like. The engine ECU acquires information (target value) representing a target driving force from another ECU (driving support ECU 10). The engine ECU drives a throttle valve of the internal combustion engine to control a driving force applied to the driving wheels. The driving force generated by the internal combustion engine is transmitted to the drive wheels via the transmission and the driving force transmission mechanism. Further, the engine ECU acquires information (control signal) regarding the shift position of the transmission that the own vehicle is equipped with. The engine ECU controls the shift position based on the information.

When the vehicle to which the vehicle control device 1 is applied is hybrid electric vehicle (HEV), the engine ECU can control the driving force of the vehicle generated by either or both of the “internal combustion engine and the electric motor” as the vehicle driving source. When the vehicle to which the vehicle control device 1 is applied is a battery electric vehicle (BEV), an electric motor ECU that controls the driving force of the vehicle generated by an “electric motor” as a vehicle driving source may be used instead of the engine ECU.

The braking device 40 applies a braking force to the wheels (brake discs). The braking device 40 includes a brake ECU, a brake caliper, and the like. The brake ECU acquires information (target value) representing the target braking force. The brake ECU controls the brake caliper to control a braking force applied to the brake disc.

The steering device 50 controls the steering angles of steered wheels (left front wheel and right front wheel). The steering device 50 includes a steering ECU, a steering mechanism, and the like. The steering device 50 further includes an actuator that drives the steering mechanism to change the steering angle. The steering ECU acquires information (target value) indicating a target steering angle. The steering ECU controls the steering angle of the steered wheels by driving the actuator based on the information.

### Operation

The driving support ECU 10 executes the vehicle speed control described below when the switch 25a is in the on-state. Further, when the switch 25a is in the on state and the switch 25b is in the on state, the driving support ECU 10 executes the steering angle control described below in addition to the vehicle speed control.

### Vehicle Speed Control

### Constant Speed Driving Control

The driving support ECU 10 determines, based on the information acquired from the in-vehicle sensor 20, whether or not there is a vehicle located in front of the host vehicle and traveling in the same direction as the host vehicle (preceding vehicle V0). When the preceding vehicle V0 does not exist, the driving support ECU 10 executes constant speed travel control. Specifically, the driving support ECU 10 controls the drive device 30 and the braking device 40 (hereinafter, referred to as a “drive device and the like”) so that the speed vs of the host vehicle matches a predetermined set speed vd (for example, a speed at which the fuel-consumption rate becomes the lowest). The set-speed vd may be changeable. When the preceding vehicle V0 is present, the driving support ECU 10 detects the velocity v0 of the preceding vehicle V0. When the detected speed v0 exceeds a predetermined speed vh, the driving support ECU 10 executes constant speed travel control.

### Inter-Vehicle Distance Holding Control

On the other hand, when the detected velocity v0 is equal to or less than the predetermined vd, the driving support ECU 10 executes the inter-vehicle distance-holding control. Specifically, the driving support ECU 10 detects (actually measures) the inter-vehicle distance D between the preceding vehicle V0 and the host vehicle based on the data acquired from the in-vehicle sensor 20. Further, the driving support ECU 10 calculates the target distance Dd of the inter-vehicle distance D based on the speed vs of the host vehicle, the speed v0 of the preceding vehicle V0, and the like.

When the speed v0 (relative speed vr=v0−vs) of the preceding vehicle V0 with respect to the speed vs of the host vehicle is larger than “0”, the inter-vehicle distance D increases. When the inter-vehicle distance D is larger than the target distance Dd, the driving support ECU 10 sets the target acceleration ad of the host vehicle such that the speed vs of the host vehicle is larger than the speed v0 of the preceding vehicle V0. Then, the driving support ECU 10 controls the drive device and the like (acceleration control) so that the acceleration α (differential value of the velocity vs) of the host vehicle coincides with the target acceleration αd. As a result, the inter-vehicle distance D is reduced, and the inter-vehicle distance D approaches the target distance Dd. When the inter-vehicle distance D coincides with the target distance Dd, the driving support ECU 10 sets the target acceleration αd of the host vehicle to “0”. That is, the driving support ECU 10 controls the drive device and the like so that the host vehicle travels at the same velocity as the preceding vehicle V0.

On the other hand, when the relative-velocity vr is smaller than “0”, the inter-vehicle distance D decreases. When the inter-vehicle distance D is smaller than the target distance Dd, the driving support ECU 10 sets the target acceleration αd of the host vehicle such that the speed vs of the host vehicle is smaller than the speed v0 of the preceding vehicle. Then, the driving support ECU 10 controls the drive device and the like so that the acceleration α of the host vehicle coincides with the target acceleration αd (hereinafter, referred to as “deceleration control”). As a result, the inter-vehicle distance D increases, and the inter-vehicle distance D approaches the target distance Dd. When the inter-vehicle distance D coincides with the target distance Dd, the driving support ECU 10 sets the target acceleration αd of the host vehicle to “0”.

The target distance Dd correlates with the speed vs of the host vehicle and the speed v0 of the preceding vehicle V0. For example, when the velocity vs and the velocity v0 are relatively small, the target distance Dd is smaller than the target distance Dd when the velocity vs and the velocity v0 are relatively large. A database (table) representing the relation between the velocity vs, v0 and the target distance Dd or a parameter defining an arithmetic expression for calculating the target distance Dd is stored in ROM 10b. The driving support ECU 10 determines the target distance Dd based on the above-described data base or the arithmetic expression.

The constant speed travel control and the inter-vehicle distance holding control may be referred to as an adaptive cruise control (ACC).

### Steering Angle Control

### Travel Race Control (1st Trace Control)

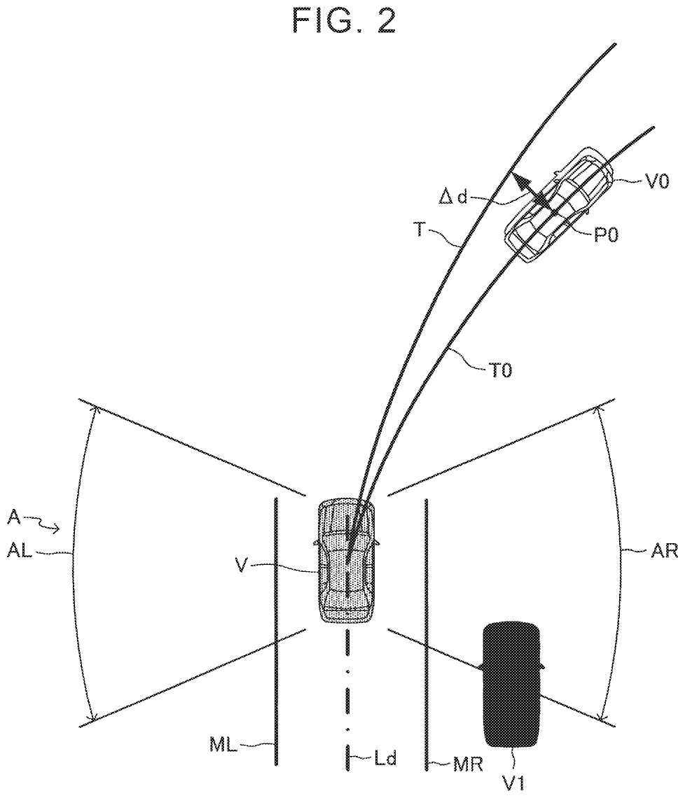

The driving support ECU 10 executes the traveling lane track control when the switch 25a is in the ON state (the constant speed traveling control or the inter-vehicle distance holding control is being executed) and the switch 25b is in the ON state. The driving support ECU 10 determines whether or not the traveling lane in which the host vehicle is traveling is recognized based on the data acquired from the millimeter-wave radar 21, the sonar 22, and the camera 23. For example, the driving support ECU 10 determines, based on the information acquired from the camera 23, whether or not the left and right lane marks (a division line, a curbstone, a separation band, and the like) that partition the traveling lane are recognized. When the lane mark is recognized, the driving support ECU 10 determines that the traveling lane is recognized. When the driving support ECU 10 determines that the traveling lane is recognized, the driving support ECU 10 calculates the target traveling line Ld. As illustrated in FIG. 2, the target traveling line Ld is a virtual line extending substantially parallel to the lane mark MR and the lane mark ML at a center position between the lane mark MR (division line, curb, separation zone, and the like) on the right side of the traveling lane on which the host vehicle is traveling and the lane mark ML on the left side. Next, the driving support ECU 10 calculates a deviation between the front end center position CL of the host vehicle and the target traveling line Ld (a deviation of the traveling lane from the widthwise right side or the left side (hereinafter, referred to as “offset-value OFS”)).

In a situation where the offset value OFS (absolute value) exceeds the threshold OFSth, the driving support ECU 10 controls the steering angle θ of the host vehicle so that the offset value OFS is decreased and matches “0”. That is, the driving support ECU 10 sets the target steering angle θd and controls the steering device 50 so that the steering angle θ coincides with the target steering angle θd.

The target steering angle θd is correlated with the offset-value OFS and the velocity vs of the host vehicle. For example, the target steering angle θd when the offset value is relatively large is larger than the target steering angle θd when the offset value is relatively small. Further, the target steering angle θd when the speed vs is relatively large is smaller than the target steering angle θd when the speed vs is relatively small. A database (table) representing the relation between the target steering angle θd, the offset-value OFS, and the velocity vs or a parameter defining an arithmetic expression for calculating the target steering angle θd is stored in ROM 10b. The driving support ECU 10 determines the target steering angle θd based on the above-described data base or the arithmetic expression.

Note that the above-described traveling lane track control may be referred to as a lane track assist (LTA).

### Trace Control of Preceding Vehicle Trajectory (Second Trace Control)

For example, in a situation in which the own vehicle is traveling in a section in which the division line is not drawn on the road surface (for example, an intersection), a section in which the division line is blurred, a section in which snow is accumulated on the road surface, or the like, the driving support ECU 10 may not be able to recognize either or both of the lane mark MR, ML. In this case, the driving support ECU 10 cannot execute the traveling lane race control described above.

When the driving support ECU 10 is unable to recognize one or both of the lane mark MR, ML while executing the inter-vehicle distance holding control and the traveling lane track control, the driving support ECU 10 controls the own vehicle so that the own vehicle passes through the same area as the area through which the preceding vehicle V0 has passed, while continuing the inter-vehicle distance holding control. That is, the driving support ECU 10 controls the drive device 30, the braking device 40, and the steering device 50 so that the host vehicle travels along the trajectory of the preceding vehicle V0.

Specifically, each time the driving support ECU 10 acquires data from the surrounding sensor at a predetermined cycle, the driving support ECU 10 corrects the steering angle θ as described below.

The driving support ECU 10 estimates the position of the preceding vehicle V0 (for example, the position P0 of the center of gravity G0 (the relative position (orientation)) with respect to the center of gravity G of the own vehicle) based on the information acquired from the surrounding sensor (see FIG. 2). The driving support ECU 10 executes the above-described inter-vehicle distance-holding control. Therefore, the distance between the host vehicle and the preceding vehicle V0 (the inter-vehicle distance D) is held at the target distance Dd.

Next, the driving support ECU 10 calculates a predicted trajectory T (a line through which the center of gravity G of the own vehicle passes) when the own vehicle travels at the present steering angle θ and the velocity vs. Next, the driving support ECU 10 calculates a deviation Δd (the shortest distance between the predicted trajectory T and the position P0) between the predicted trajectory T and the position P0. Then, the driving support ECU 10 corrects the steering angle θ so that the deviation Δd becomes “0”. That is, the driving support ECU 10 calculates a target trajectory T0 passing through the position P0, and calculates a target steering angle θd at which the subject vehicle can travel along the target trajectory T0. Then, the driving support ECU 10 controls the steering device 50 so that the steering angle θ coincides with the target steering angle θd. For example, when the target trajectory T0 is located on the right side of the predicted trajectory T, the driving support ECU 10 controls the steering angle θ so that the own vehicle steers to the right. On the other hand, when the target trajectory T0 is located on the left side of the predicted trajectory T, the driving support ECU 10 controls the steering angle θ so that the subject vehicle steers leftward.

However, the driving support ECU 10 does not recognize the traveling lane of the host vehicle while the preceding vehicle trajectory tracing control is being executed. Therefore, when the steering angle θ is controlled so that the traveling direction of the preceding vehicle V0 changes and the traveling direction of the host vehicle is changed so as to follow the change, there is a possibility that the host vehicle approaches or contacts the other vehicle (the parallel-traveling other vehicle) V1 running in parallel with the host vehicle. In order to suppress such approach or touching of the parallel-traveling other vehicle V1, when there is a possibility that the parallel-traveling other vehicle V1 running exists, the driving support ECU 10 does not execute the preceding vehicle trajectory tracing control. Specifically, the driving support ECU 10 sequentially determines whether or not to detect the other vehicle V1 traveling in the same direction as the own vehicle in the area A (AL, AR) including the side area of the own vehicle and the front and rear areas (front and rear side areas) based on the information acquired from the surrounding sensor. When the driving support ECU 10 detects the other vehicle V1 in the area A, it is rare that it is erroneous detection, but it is highly probable that the other parallel-running vehicle is actually present. Therefore, the driving support ECU 10 determines that there is a possibility that there are other vehicles running side by side.

It should be noted that “the driving support ECU 10 detects the other vehicle V1 in the area A” is only one example of the condition Y in which the proposition X “there is a possibility that the other vehicle running in parallel” is “true”. For example, it is determined whether or not the driving support ECU 10 detects the other vehicle V1 running in parallel in the area AR (or AL) located on the right side (or left side) of the host vehicle when the traveling direction of the host vehicle is to be changed in the right direction (or left direction) by the preceding vehicle trajectory tracing control. When the condition Y “the other vehicle V1 running in parallel in the area AR (or AL) is detected” is satisfied, the driving support ECU 10 determines “there is a possibility that the other vehicles running in parallel exist”.

When the condition Y is satisfied, the driving support ECU 10 controls an indicator (not shown), a buzzer, and the like to notify the driver that the steering angle control and the inter-vehicle distance holding control cannot be executed. After that, the driving support ECU 10 ends executing the steering angle control and the inter-vehicle distance holding control. Here, the driving support ECU 10 may execute the constant speed traveling control or may terminate the vehicle speed control.

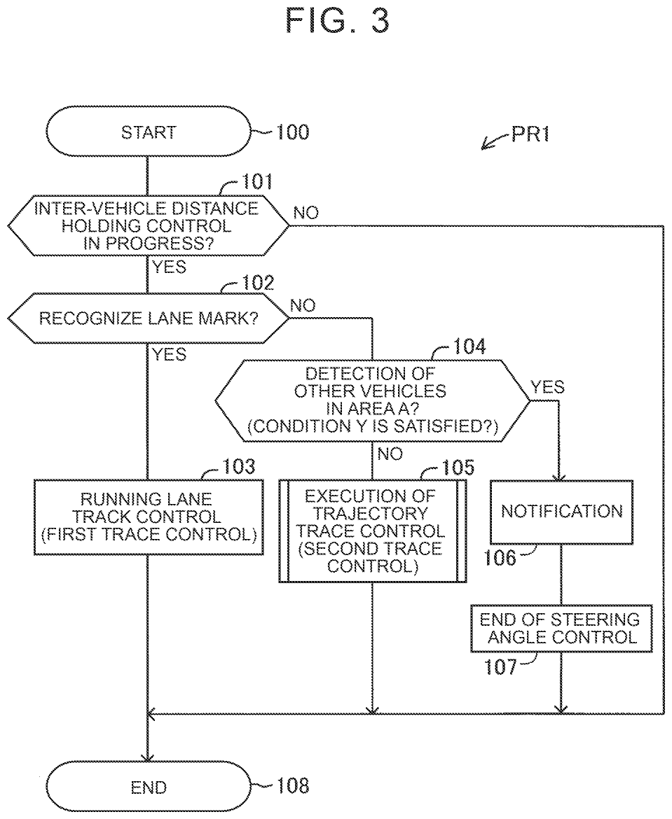

Next, referring to FIG. 3, a programming PR1 executed by a CPU 10a (hereinafter referred to as “CPU”) of the driving support ECU 10 in order to execute the steering angle control will be described.

When the switch 25a and the switch 25b are in the on-state, CPU starts executing the programming PR1 at a predetermined cycle. CPU starts executing the programming PR1 from step 100 and proceeds to step 101.

In step 101, CPU determines whether or not the inter-vehicle distance-holding control is being executed. If the inter-vehicle distance holding control is being executed (101: Yes), CPU proceeds to step 102. On the other hand, when the inter-vehicle distance holding control is not executed (101: No when the constant speed traveling control is executed), CPU proceeds to step 108. Then, CPU finishes executing the programming PR1.

CPU proceeds to step 102 to determine whether the lane mark ML and the lane mark MR are recognized. When CPU recognizes the lane mark ML and the lane mark MR (102: Yes), CPU determines that the traveling lane of the host vehicle is recognized and proceeds to step 103. On the other hand, when the CPU does not recognize one or both of the lane mark ML and the lane mark MR (102: No), CPU determines that the traveling lane of the host vehicle is not recognized and proceeds to step 104.

CPU proceeds to step 103 to execute the traveling lane race control. Then, CPU proceeds to step 108 and ends executing the programming PR1.

When CPU proceeds to step 104, it determines whether or not the parallel-traveling other vehicle V1 is detected in the area A consisting of the side, the front side, and the rear side of the host vehicle, that is, whether or not the condition Y is satisfied. If the parallel-traveling other vehicle V1 is not detected in the area A (104: No), CPU proceeds to step 105.

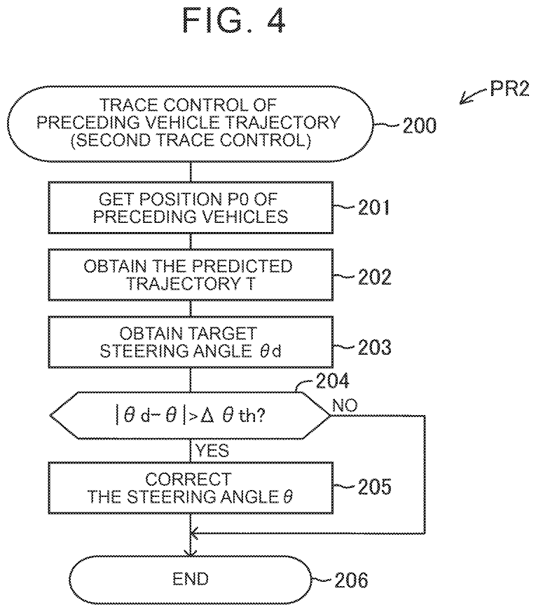

CPU proceeds to step 105 to execute the preceding vehicle trajectory tracing control. FIG. 4 shows a programming PR2 executed by CPU to execute the preceding vehicle trajectory tracing control. As illustrated in FIG. 4, when the preceding vehicle trajectory tracing control is started to be executed in step 200, CPU proceeds to step 201 and acquires (calculates) the position P0 of the preceding vehicle V0. CPU then proceeds to step 202.

CPU proceeds to step 202 to acquire (calculate) the predicted trajectory T of the host vehicle. CPU then proceeds to step 203.

CPU proceeds to step 203 to acquire (calculate) the target steering angle θd. CPU then proceeds to step 204.

When CPU proceeds to step 204, it is determined whether or not the angular difference Δθ (absolute value), which is the difference between the target steering angle θd and the present steering angle θ, exceeds the minute threshold Δθth. If the angular difference Δθ exceeds the threshold Δθth (204: Yes), CPU proceeds to step 205. On the other hand, when the angular difference Δθ is equal to or smaller than the threshold Δθth (204: No), CPU proceeds to step 206 and ends the programming PR2.

CPU proceeds to step 205 to correct the steering angle θ. Accordingly, the steering device 50 is controlled so that the steering angle θ coincides with the target steering angle θd. Then, CPU proceeds to step 206 and ends executing the programming PR2.

Further, in step 104 of FIG. 3, when the parallel-traveling other vehicle V1 is detected in the area A (104: Yes), CPU proceeds to step 106. CPU controls the display device and the like to notify the driver that the preceding vehicle trajectory tracing control cannot be executed. Then, CPU proceeds to step 107 and ends the steering angle control. Therefore, when it is determined in step 104 that CPU has not detected the parallel-traveling other vehicle V1 in the area A, the preceding vehicle trajectory tracing control is not executed. Thereafter, CPU proceeds to step 108 to terminate executing the programming PR1. When CPU proceeds to step 107, if the steering angle control is not executed, CPU skips step 107 and proceeds to step 108.

### Effect

According to the present embodiment, in a case where there is a possibility that other vehicles running side by side exist in the area A, specifically, in a case where the parallel-traveling other vehicle V1 is detected in the area A, the preceding vehicle trajectory tracing control is not executed. Therefore, by executing the preceding vehicle trajectory tracing control, it is possible to prevent the host vehicle from approaching or touching the parallel-traveling other vehicle V1. As described above, according to the vehicle control device 1, it is possible to improve the safety of the host vehicle.

The present disclosure is not limited to the above embodiment, and various modifications can be adopted within the scope of the present disclosure.

### Modification 1

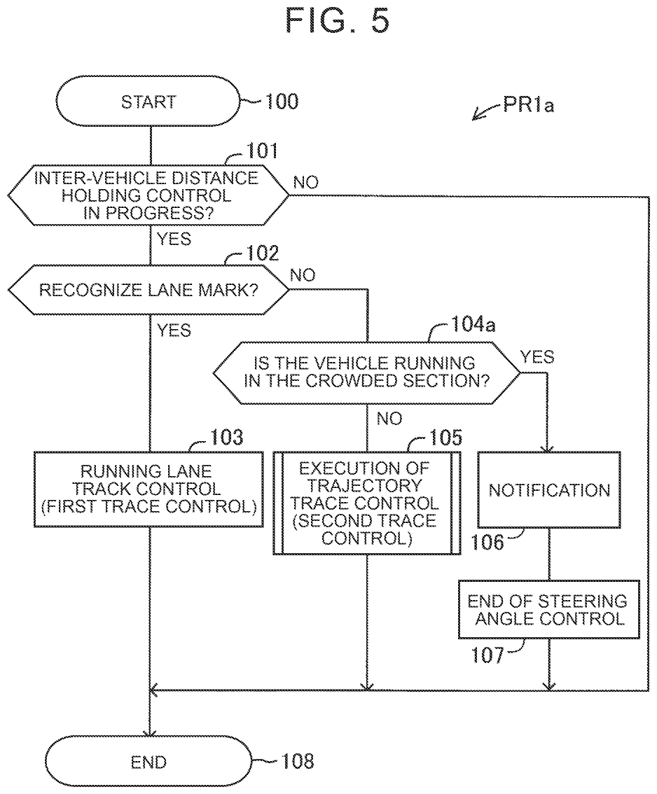

The in-vehicle sensor 20 may include a communication device 26 connected to a predetermined server computer via a wireless communication line. The driving support ECU 10 receives, from the server computer via the communication device 26 and the radio communication line, traffic information regarding a traffic condition of a traveling lane on which the host vehicle is traveling and/or a traveling lane adjoining the traveling lane. Then, as illustrated in FIG. 5, the driving support ECU 10 determines whether or not the host vehicle is traveling in the congested section. Specifically, the driving support ECU 10 determines that the host vehicle is traveling in the congestion section when the congestion level represented by the traffic data (for example, the number of other vehicles located in an area separated from the host vehicle by a predetermined distance from the front and rear of the host vehicle) exceeds a threshold value. Then, when the condition that “the host vehicle is traveling in the congested section” is satisfied (step 104a: Yes), the driving support ECU 10 determines that there is a possibility that there is another vehicle that travels in parallel, and ends executing the programming PR1a. In other words, the driving support ECU 10 does not execute the preceding-vehicle trajectory tracing control.

### Modification 2

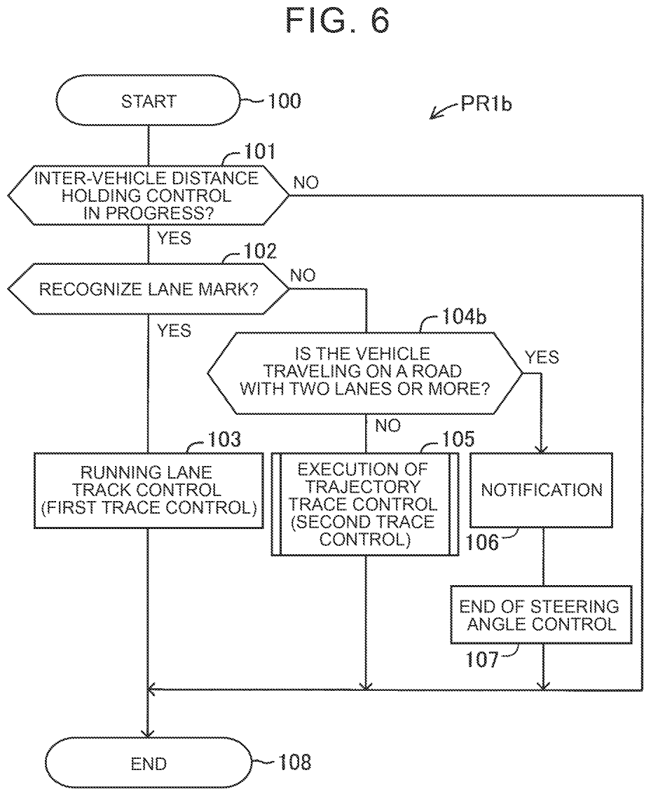

The in-vehicle sensor 20 may include a navigation system 27. The driving support ECU 10 acquires, from the navigation system 27, information about the present location of the host vehicle and the configuration of the roadway (the number of traveling lanes) in the vicinity thereof. Then, as shown in FIG. 6, when the condition Y is satisfied that “the host vehicle is traveling on a road of two lanes or more (adjacent lanes exist)” is satisfied based on the information (step 104b: Yes), the driving support ECU 10 determines that there is a possibility that there is another vehicle running in parallel, and ends executing the programming PR1b. In other words, the driving support ECU 10 does not execute the preceding-vehicle trajectory tracing control.

What is claimed is:

1. A vehicle control device comprising:
an in-vehicle sensor that acquires information on an object present around a host vehicle and information on a traveling state of the host vehicle; and
a processor that is able to execute first trace control in which, based on the information acquired from the in-vehicle sensor, a traveling lane in which the host vehicle is traveling is recognized and the host vehicle is controlled to move along the traveling lane, and that is able to execute second trace control in which, when there is a preceding vehicle that is traveling in front of the host vehicle under a situation in which the traveling lane is not able to be recognized during execution of the first trace control, the host vehicle is controlled to move along a trajectory of the preceding vehicle, wherein the processor is configured not to execute the second trace control when there is a possibility that another vehicle traveling side by side with respect to the host vehicle is present.

2. The vehicle control device according to claim 1, wherein when another vehicle located in a predetermined range including a lateral side of the host vehicle is detected based on the information acquired from the in-vehicle sensor, the processor determines that there is a possibility that the other vehicle traveling side by side with respect to the host vehicle is present.

3. The vehicle control device according to claim 1, wherein when determination is made that the host vehicle is traveling in a congested section, the processor determines that there is a possibility that the other vehicle traveling side by side with respect to the host vehicle is present.

4. The vehicle control device according to claim 1, wherein when the host vehicle is traveling on a road in which the number of lanes in a traveling direction of the host vehicle is two or more, the processor determines that there is a possibility that the other vehicle traveling side by side with respect to the host vehicle is present.

5. The vehicle control device according to claim 1, wherein the processor stops control of the host vehicle, when determination is made that there is a possibility that the other vehicle traveling side by side with respect to the host vehicle is present, under the situation in which the traveling lane is not able to be recognized.
